(19) United States
(12) Patent Application Publication
(10) Pub. No.: US 2013/0138280 A1
(43) Pub. Date: May 30, 2013

(54) ENGINE START STABILIZATION METHOD IN HYBRID POWER SYSTEM

(71) Applicant: Jongpil Kim, Seoul (KR)

(72) Inventor: Jongpil Kim, Seoul (KR)

(73) Assignees: Kia Motors Corporation, Seoul (KR); Hyundai Motor Company, Seoul (KR)

(21) Appl. No.: 13/524,467

(22) Filed: Jun. 15, 2012

(30) Foreign Application Priority Data
Nov. 30, 2011 (KR) 10-2011-0126783

(51) Int. Cl. B60W 20/00; B60W 10/08; B60W 10/06

(52) U.S. Cl. 701/22; 701/1

(57) ABSTRACT

An engine start stabilization method in a hybrid power system may include: attempting HSG-engine start that attempts to start an engine with an HSG belt; recognizing slipping of the HSG belt that determines whether the possibility of slipping of the HSG belt is high, and whether a condition revolution of the HSG and a crankshaft is suitable are checked, in the HSG-engine start; checking slipping of the HSG belt that attempts again the HSG-engine start, with the HSG-belt not slipping, when the possibility of slipping of the HSG belt is determined to be high, during a traveling state by using a driving motor when the HSG-engine start fails; and storing an HSG-belt slipping condition applied to determine whether the possibility of slipping of the HSG belt is high, and applies some of the stored condition values as prior values, when the HSG-engine is started after the engine is stopped.

### CROSS-REFERENCE TO RELATED APPLICATIONS

The present application claims priority to Korean Patent Application Number 10-2011-0126783 filed Nov. 30, 2011, the entire contents of which application is incorporated herein for all purposes by this reference.

### BACKGROUND OF THE INVENTION

1. Field of the Invention

The present invention relates to a hybrid vehicle, and particularly, to an engine start stabilization method in a hybrid power system which can prevent a belt from being damaged or worn by immediately changing the driving mode into an engine start mode using a driving motor when the belt of an HSG (Hybrid Starter & Generator) connected with the engine by the belt slips.

2. Description of Related Art

In general, hybrid vehicles are operated in a hybrid mode that assists the output torque from the engine with a driving motor when a larger load is applied to the vehicle, such as starting of the engine, accelerating, or traveling on an incline, whereas the hybrid vehicles are operated in an engine mode or a motor mode, or a combination mode using both the engine and motor, for traveling at a constant speed.

The hybrid vehicles uses not a driving motor, but an HSG (Hybrid Starter & Generator), which is a small motor taking exclusive charge of starting the engine, and operating as a power generator for charging a battery, when the engine is started.

Therefore, the hybrid vehicle are generally equipped with one large-capacity motor for driving and one small-capacity motor (HSG, Hybrid Starter & Generator) for starting the engine.

In the HSG type of hybrid vehicles, starting of an engine for generating engine power that is transmitted to the transmission through the clutch is implemented by HSG driving which uses the belts of the engine's auxiliary components.

However, there is necessarily a possibility of failing to start the engine in a type that starts the engine with a belt transmitting to the torque from an HSG to the engine, because the belt may slip due to a change in a friction force between the belt and the pulley.

Therefore, a slip detecting unit is used to ensure stability against the belt slip and is implemented by a logic based on the number of revolution, as in FIG. 5.

Referring to FIG. 5, a slip detection logic detects the number of revolution (RPM, Kb) of an engine, using an engine-side crankshaft position sensor, detects the number of revolution (RPM, Ka) of the HSG, using an resolver sensor of the HSG, and then checks whether the belt has slipped, using the difference between the number of revolution (RPM, Kb) of the engine and the number of revolution (RPM, Ka) of the HSG.

However, the slip detection unit has a limit that it just detects slip, but cannot practically prevent the slip, and particularly, slip necessarily occurs frequently, when the increase rate of the number of revolution (RPM) is high and the diameter of the pulley of the belt is relatively small, such as the HSG.

Frequent slip of the belt means that the belt keeps receiving friction heat due to the slip, and the continuous friction heat applied to the belt may deteriorate the belt, which increases the surface temperature of the belt.

Accordingly, it results in a large increase in possibility of breakdown of the belt due to the accumulated deterioration.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an engine start stabilization method in a hybrid power system that can protect a belt from breakdown due to deterioration by friction heat generated when the engine slips, by preventing further slipping of an HSG (Hybrid Starter & Generator) belt, by rapidly changing the driving mode in to an engine start mode using a driving motor when the belt of the HSG slips, even if the engine is started by the HSG connected with the engine by the belt.

Further, various aspects of the present invention are directed to providing an engine start stabilization method in a hybrid power system which can keep a vehicle traveling by driving a driving motor, according to the charged amount of a battery, even if the belt of an HSG is damaged, by rapidly changing power transmission with the driving motor when there is problem in the HSG during starting of the engine.

An exemplary embodiment of the present invention provides an engine start stabilization method in a hybrid power system, including a HSG belt protection logic that may include attempting HSG-engine start that attempts to start an engine with an HSG (Hybrid Starter & Generator) belt, recognizing slipping of an HSG belt that determines whether the possibility of slipping of the HSG belt is high, after whether a condition for the number of revolution of the engine (RPM) is suitable and whether a condition for the number of revolution of the HSG (RPM) and the number of revolution of a crankshaft (CRK RPM) is suitable are checked, in the HSG-engine start, checking slipping of the HSG belt that attempts again the HSG-engine start, with the HSG-belt not slipping, when the possibility of slipping of the HSG belt is high, and maintains the traveling state by using a driving motor when the HSG-engine start fails, and storing an HSG-belt slipping condition that stores the condition applied to determine whether the possibility of slipping of the HSG belt is high, and applies some of the stored condition values as prior values, when the HSG-engine start is attempted after the engine is stopped

The recognizing of slipping of the HSG belt is performed by a continuous condition mode that determines whether the possibility of slipping the HSG belt is high, on the basis of whether the number of revolution of the engine (RPM) satisfies the condition of the minimum number of revolution of the engine (Es)<a specific number of revolution of the engine, whether the condition of the difference of the numbers of revolution (Esd)=[the number of revolution of the HSG (HSG RPM) x pulley ratio]−[the number of revolution of the crankshaft (CRK RPM)]}>another specific number of revolution of the engine is satisfied when the condition is satisfied, and whether the satisfaction of the conditions satisfies a predetermined continuation time (Te), and an accumulation condition mode that determines whether the possibility of slipping the HSG belt is high, on the basis of whether the condition of the difference of the accumulated number of revolution (Esds) generated between the number of revolution of the HSG (RPM) and the number of revolution of the crankshaft (CRK RPM)>another specific number of revolution of the engine is satisfied and whether the accumulated numbers of time of the satisfaction of the conditions (Ss)=a predetermine number of times.

The continuous condition mode and the accumulation condition mode are Or-condition

When the conditions of the continuous condition mode and the accumulation condition mode are not satisfied, it is determined that the possibility of slipping of the HSG belt when the engine is started by the HSG is very low, and a normal traveling mode is implemented.

The specific number of revolution of the engine in the condition of the minimum number of revolution of the engine (Es)<a specific number of revolution of the engine in the continuous condition mode is 500 RPM, the another specific number of revolution of the engine in the condition of the difference of the numbers of revolution (Esd)={[the number of revolution of the HSG (HSG RPM) x pulley ratio]−[the number of revolution of the crankshaft (CRK RPM)]}>another specific number of revolution of the engine is 300 RPM and 900 RPM, and the continuation time (Te) is eight seconds.

When it is satisfied that the another specific number of revolution of the engine is 300 RPM, whether the another specific number of revolution of the engine is 900 RPM is determined.

The another specific number of revolution of the engine in the condition of the difference of the accumulated number of revolution (Esds)>another specific number of revolution of the engine in the accumulation condition mode is 1000 RPM and the specific number of times in the accumulate numbers of times (Ss)=a specific number of times is one hundred times at 200,000 RPM.

The checking of slipping of the HSG belt is performed by an immediate action mode logic that when the HSG-engine start fails and the possibility of slipping of the HSG belt is high, keeps an EV (motor) traveling mode when the vehicles is traveling , or implements an HEV (engine+motor) traveling mode after operating a motor when the vehicle is not stopped, and implements the EV (motor) traveling mode after the motor is operated when failure of the HSG-engine start is further checked, and prevents engine stop until the HSG belt protection logic is initialized, and then prevents an attempt of the HSG-engine start, and an external handling logic that records and stores information applied to determine whether the possibility of slipping of the HSG belt is high.

Continuation of the EV (motor) traveling mode is checked, the implementation of the HEV (engine+motor) traveling mode is checked after the motor is operated, and then the implementation of the EV (motor) traveling mode after the motor is operated is checked.

When the immediate action mode logic is not performed, whether MP-DTC stored prior to P-DTC is detected with the P-DTC, which is pending DTC, is determined as the reference of determination, when the MP-DTC is detected and until the HSG belt protection logic is initialized, engine stop is prevented and then the attempt of the HSG-engine start is prevented, the HEV (engine+motor) traveling mode is implemented after the motor is operated in an IG ST attempt when the MP-DTC is not detected, and the when it is checked that the P-DTC is removed by continuous checking, a delay action mode logic that initializes the HSG belt breakdown determination is implemented.

The external handling logic stores P-DTC that is a pending DTC and turns on a warning light, determines the number of times of breakdown of the HSG belt and turns on another warning light and continuously checks whether a condition of turning off the light is satisfied, determines whether a condition of storing the P-DTC as C-DTC that is a confirm DTC is satisfied, turns on another warning light when the condition of storing C-DTC is satisfied, stores the C-DTC when the number of times whether a warm-up cycle normally continues is satisfied, and uses the C-DTC as information when the HSG belt protection logic is repeated.

A service warning light is turned on and is turned off when a condition of turning off the service warning light is satisfied, when the number of times of HSG belt breakdown determination is one time, an MIL warning light is turned on and is turned off when a condition of turning off the MIL warning light is satisfied, when the number of times of HSG belt breakdown determination is one or more times (two times and three times), and the condition satisfying the C-DTC storing is HSG belt breakdown determination=one or more times (two times and three times).

According to the exemplary embodiments of the present invention, even if the engine is started by the HSG(Hybrid Starter & Generator) connected with the engine by a belt, it is possible to immediately stop proceeding of slipping of the HSG belt by rapidly starting the engine with a driving motor when the HSG belt slips.

According to the exemplary embodiments of the present invention, it is possible to protect the belt not to be damaged by deterioration due to friction heat, even if the HSG belt slips, by immediately stopping proceeding of the slipping of the HSG belt.

According to the exemplary embodiments of the present invention, it is possible to keep the vehicle traveling by operating a driving motor, according to the charged amount of a battery, even if the HSG belt is broken, by rapidly supplying power from the driving motor when there is a problem in the HSG when the engine is started, thereby significantly strengthening stability.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 shows an engine start stabilization logic in a hybrid power system according to an exemplary embodiment of the present invention.

FIGS. 2 to 4 show engine start stabilization logics in the hybrid power system of FIG. 1.

FIG. 5 shows a slip detection curve of a belt of an HSG that is a typical small motor for starting an engine.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

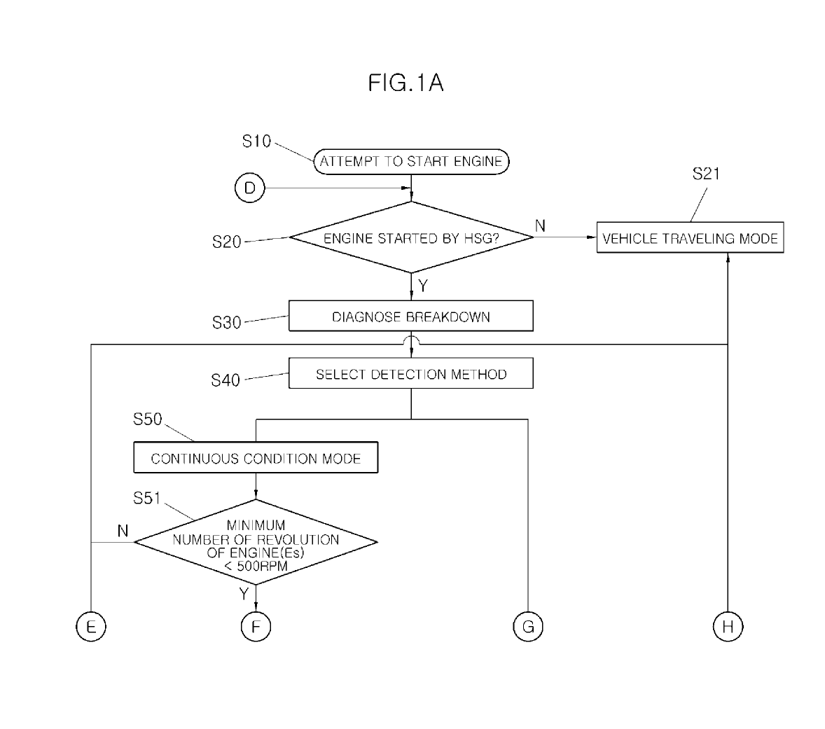

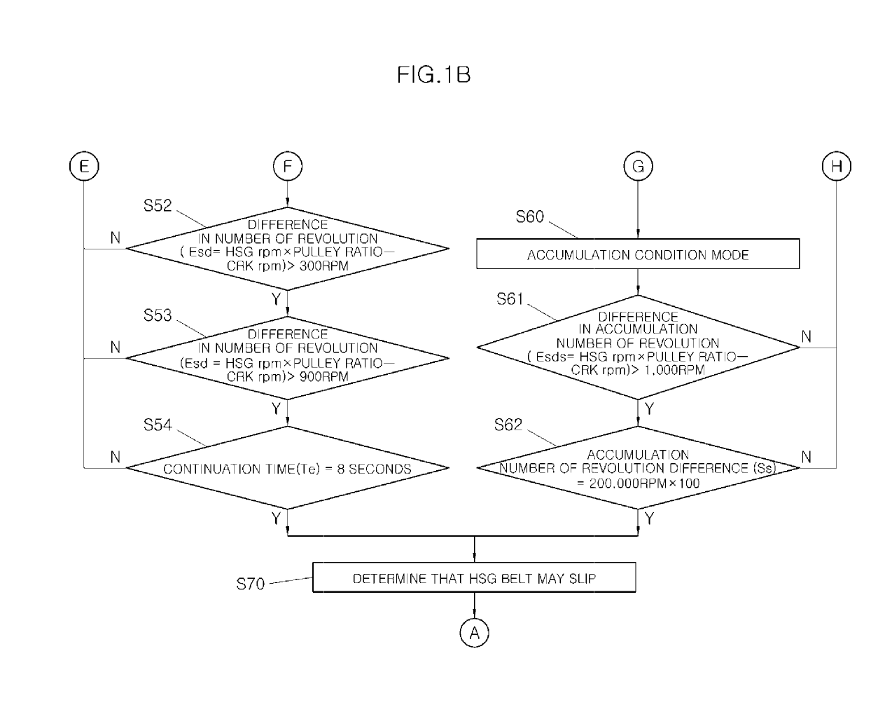

Referring to FIG. 1, step S20 checks whether there is an attempt to start an engine, using an HSG (Hybrid Starter & Generator) in engine start in step S10, and when there is an attempt to start the engine with the HSG, an HSG belt protection logic is performed, as in step S30, and a breakdown is checked.

The attempt to start the engine in step S10 may be performed in the EV mode where a vehicle is driven by a driving motor or an HEV mode that is an engine+motor mode.

A process of selecting a detection method, as in step S40, is performed first in the HSG belt protection logic.

The detection method is separately performed in a continuous condition mode of step S50 or an accumulation condition mode of step S60.

The continuous condition mode of step S50 is implemented through step S51 to step S54 and the accumulation condition mode of step S60 is implemented through step S61 and step S62.

As a result from the steps, when it is determined that the HSG belt can slip in step S70, it is determined that the possibility of slipping of the HSG belt is very high.

As the continuous condition mode of step S50 is performed, it is checked whether the number of revolution (RPM) of the engine satisfies a predetermined condition, as in step S51.

The number of revolution (RPM) of the engine considered in this case is the minimum number of revolution (Es) of the engine, which is set in a condition of the minimum number of revolution (Es) of the engine <500 RPM.

When the condition of the minimum number of revolution (Es) of the engine <500 RPM of step S51 is satisfied, the process proceeds to step S52 and it is checked whether other conditions are satisfied.

The condition considered in this case is a difference in the numbers of revolution (Esd), and for the condition, the number of revolution of the HSG (HSG RPM) and the number of revolution of the crankshaft (CRK RPM) are used and the condition set for this case is set in a condition of the difference of the numbers of revolution (Esd)={[the number of revolution of the HSG (HSG RPM)×pulley ratio]−[the number of revolution of the crankshaft (CRK RPM)]}>300 RPM.

The pulley ratio is based on the connection between an HSG pulley and a crankshaft pulley by a belt.

When the condition of the difference of the numbers of revolution (Esd)={[the number of revolution of the HSG (HSG RPM)×pulley ratio]−[the number of revolution of the crankshaft (CRK RPM)]}>300 RPM of step S52 is satisfied, the process proceeds to step S53 and it is checked whether another condition is satisfied.

The condition considered in this case is the same as the difference in the number of revolution (Esd) and the reference for determination increases to 900 RPM from 300 RPM.

That is, the condition set in this case is determined by the condition of the difference in the number of revolution (Esd)={[the number of revolution of the HSG (HSG RPM)×pulley ratio]−[the number of revolution of the crankshaft (CRK RPM)]}>900 RPM.

As described above the reason of double-checking of the difference in the number of revolutions (Esd), by 300 RPM in step S52 and 900 RPM in step S53, is for increasing reliability of whether the belt slips.

When the condition of the difference in the number of revolution (Esd)={[the number of revolution of the HSG (HSG RPM)×pulley ratio]−[the number of revolution of the crankshaft (CRK RPM)]}>900 RPM of step S53 is satisfied, the process proceeds to step S54 and the continuation time (Te) of the condition of the difference in the number of revolution (Esd)>900 RPM is checked.

The continuation time (Te) is set to 8 second.

When the checks in step S51 to step S54 are positive, it is determined that the HSG belt can slip, as in step S70, which means that the possibility of slipping of the HSG belt is very high when the engine is started with the HSG.

As the accumulation condition mode of S60 is performed, as in step S61, it is checked whether the difference of the accumulated number of revolution (Esds) generated between the number of revolution of the HSG (RPM) and the number of revolution of the crankshaft (CRK RPM) satisfies a predetermined condition.

In this case, a condition, the difference of the accumulated number of revolution (Esds)={[the number of revolution of the HSG (HSG RPM)×pulley ratio]−[the number of revolution of the crankshaft (CRK RPM)]}>1000 RPM, is set.

When the condition of the difference of the accumulated number of revolution (Esds)>1000 RPM of step S61 is satisfied, the process proceeds to step S62 and the accumulated number of the difference in the number of revolution (Ss)=200,000 RPM is checked one hundred times.

When the checks in step S61 and step S62 are positive, it is determined that the HSG belt can slip, as in step S70, which means that the possibility of slipping of the HSG belt is very high when the engine is started with the HSG.

However, when the conditions of steps S51 to S54 and the conditions of step S61 to step S62 are not satisfied, there is little possibility of slipping of the HSG belt when the engine is started with the HSG, such that the process proceeds to step S21 and the vehicle enters the normal traveling mode.

On the other hand, when it determined that the possibility of slipping of the HSG belt is very high when the engine is started by the HSG, the HSG belt protection logic performs both of a self-removal logic and an external-handling logic.

The self-removal logic is a measure against when the possibility of slipping of the HSG belt is very high and the external-handling logic is a measure of recording information against when the possibility of slipping of the HSG belt is very high.

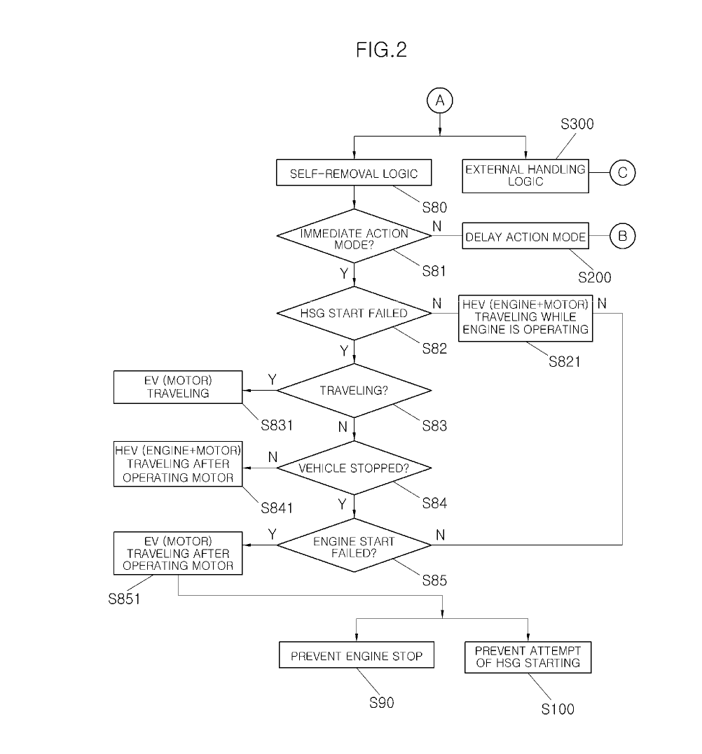

Referring to FIG. 2, as the self-removal logic of step S80 is performed in the HSG belt protection logic, an immediate action mode determining whether to immediately handle a breakdown of the HSG belt, which is determine din step S81, is implemented.

If the immediate action mode is not requested, the process proceeds to step S200 and a logic according to a delay action mode is performed.

Next, after it is checked that the starting with the HSG fails in step S82, when the HSG starting state is implemented in spite of the very high possibility of slipping of the HSG belt, the process proceeds to step S821 and an HEV (engine+motor) traveling mode according to a normal engine state is performed.

On the contrary, when the starting with the HSG fails due to the very high possibility of slipping of the HSG belt in step S82, the process proceeds to step S83 and whether the vehicle is traveling is determined.

When the vehicle is traveling, the EV traveling mode can be maintained by keeping the driving state of the motor of step S831.

However, when it is determined that the vehicle is not traveling in step S83, the process proceeds to step S84 and further determines whether the vehicle has been stopped.

When the vehicle has not been stopped, the motor is operated and the HEV (engine+motor) traveling mode is performed, as in step S841.

On the contrary, when it is determined that the vehicle has stopped in step S84, the process proceeds to step S85 and determines again whether the starting with the HSG fails, and then, when the starting with the HSG has failed, the motor is operated and the EV (motor) traveling mode is implemented, as in step S851, while when the engine has been started by the HSG, the process proceeds to step S821 and the vehicle enters the HEV (engine+motor) traveling mode.

The HSG belt protection logic prevents the engine from stopping, as in step S90, and also prevents following starting with the HSG, as in step S100.

Step S90 and step S100 are kept until the HSG belt protection logic is initialized.

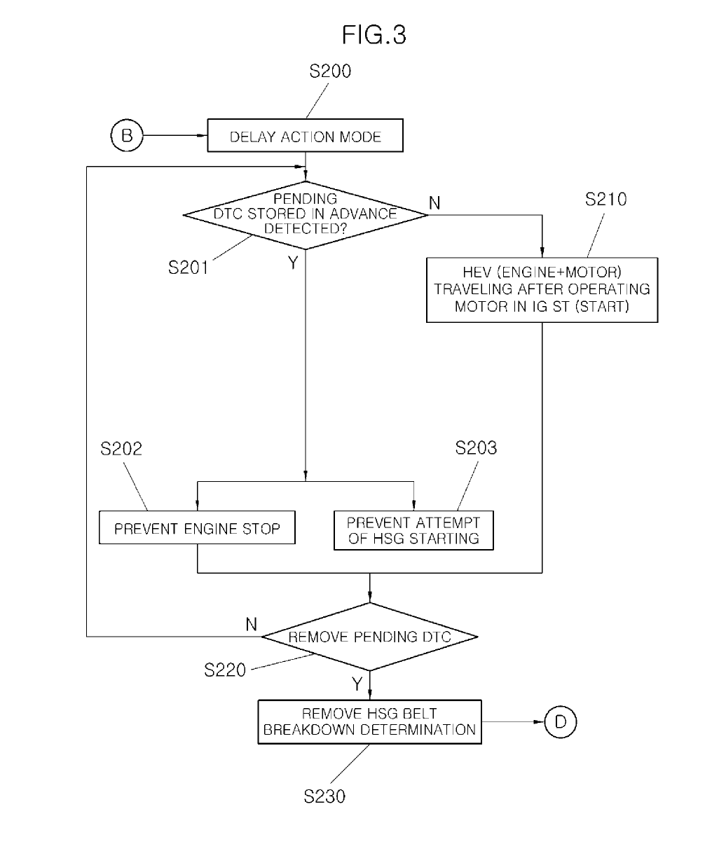

On the other hand, referring to FIG. 3, when the process enters the delay action mode of step S200 in the self-removal logic of the HSG belt protection logic, it is determine whether MP-DTC that is a value stored prior to P-DTC is detected, with the P-DTC as the reference of determination which is pending DTC (Pending DTC), as in step S201.

The MP-DTC implies C-DTC that is confirm DTC (Confirm DTC) in the following step S320 to step S350.

When M-PDTC is detected, as the result of detection of MP-DTC in step S201, the HSG belt protection logic prevents the engine from stopping, as in step S202, and also prevents following starting with the HSG, as in step S203, while when the MP-DTC is not detected, the motor is operated in an attempt of IG ST and the vehicle enters the HEV (engine+motor) traveling mode.

Next, as in step S220, whether to the P-DTC has been removed is continuously checked, and when the P-DTC has been removed, the process returns to before the HSG belt protection logic is performed, by initializing the HSG belt breakdown determination state performed through the processes, as in step S230.

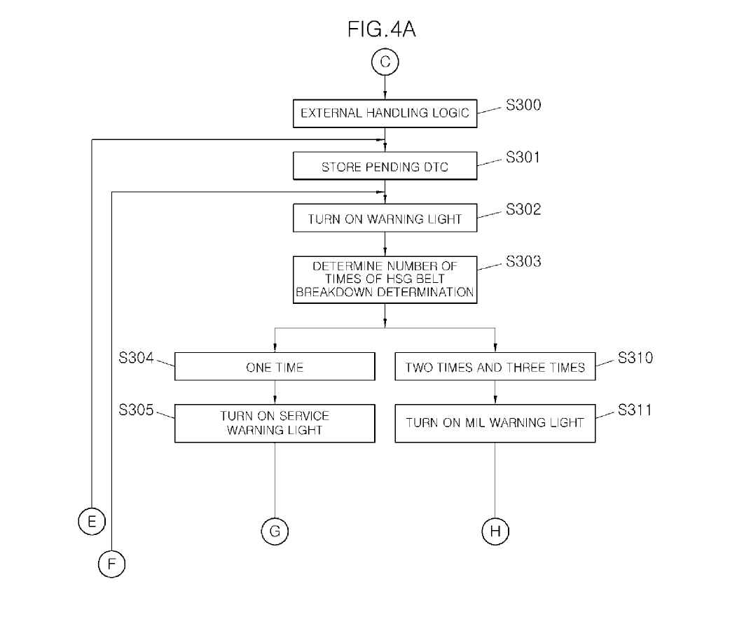

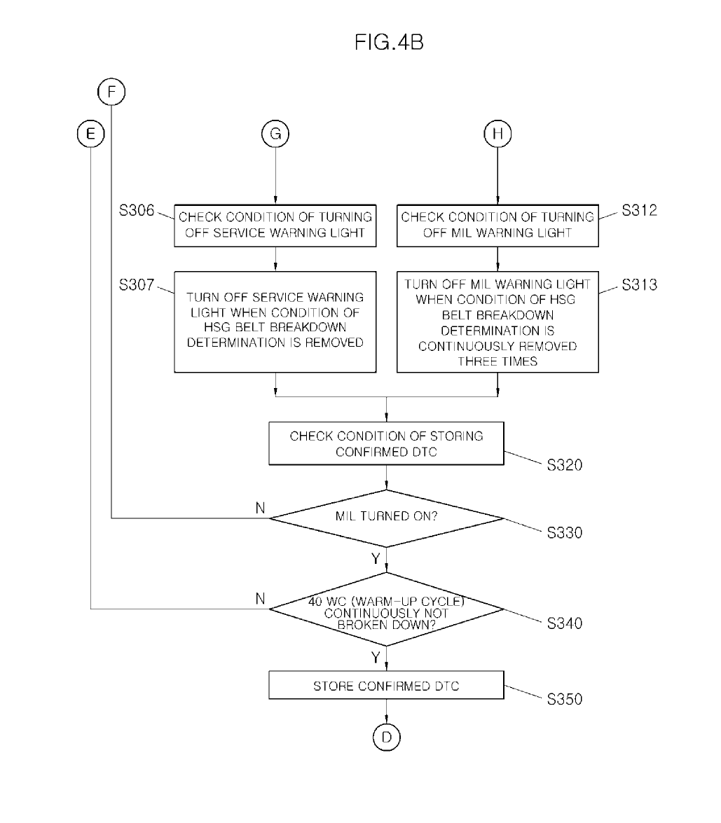

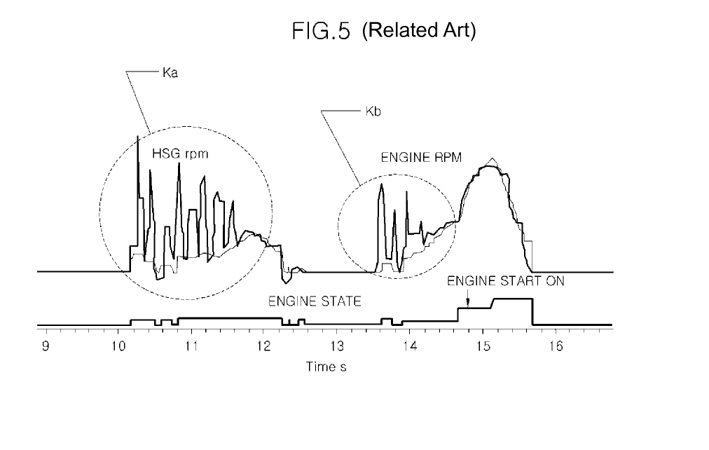

Referring to FIG. 4, after it is determined that the possibility of slipping of the HSG belt when the engine is started by the HSG is very high, it is possible to know the external handling logic of the HSG belt protection logic which records and stores the information on the determination.

When the external handling logic is performed, P-DTC that is pending DTC is stored, as in step S301.

It was described above that the P-DTC is calculated from the delay action mode (step S200 to step S230) described above.

When the P-DTC is stored in step S301, it is shown by immediately turning on a warning light, as in step S302, and then, as in step S303, the process enters a process of determining the number of times of determining a breakdown of the HSG belt.

The process is divided into step S304 to step S307 where the HSG belt breakdown determination was performed one time, and step S310 to step S313 where the HSG belt breakdown determination was performed one or more times (two times and three times).

When the HSG belt breakdown determination was performed one time, as in step S304, a service warning light is turned on in step S305, and then the process proceeds to step S306 and continuously checks whether the condition of turning off the service warning light is satisfied, and then when the condition of turning off the service warning light is satisfied, the service warning light is turned off, as in step S307.

On the contrary, when the HSG belt breakdown determination was performed one or more times (two times and three times), as in step S310, an MIL warning light is turned on in step S311, and then the process proceeds to step S312 and continuously checks whether the condition of turning off the MIL warning light is satisfied, and when the condition of turning off the MIL warning light is satisfied, the MIL warning light is turned off, as in step S313.

Next, when the process enters step S320, whether the condition of storing the P-DTC stored in step S301 as C-DTC that is the confirm DTC is satisfied is determined.

When it is determined that the condition of storing as C-DTC is satisfied in step S320, the MIL warning light is turned on when the HSG belt breakdown determination was performed one or more times (two times and three times),a s in step S330.

Next, the process proceeds to step S340 and the normal number of times where an warm-up cycle continues is determined.

When the number of times where the warm-up cycle continues is about forty times in step S340, the process proceeds to step S350 and the C-DTC is stored, such that it is used to determine whether MP-DTC is detected, which is the value stored prior to P-DTC of the delay action mode in step S200, when the HSG belt protection logic is repeated.

As described above, in the exemplary embodiment, the HSG belt protection logic detects first the possibility of slipping of the HSG belt, using the continuous condition mode for checking whether the set condition of the number of revolution of the engine (RPM) is suitable, or the accumulation condition mode for checking whether the accumulated number of revolution of the number of revolution of the HSG (RPM) and the number of revolution of the crankshaft (CRK RPM) is suitable.

When the possibility of slipping of the HSG belt is very high, after the possibility of slipping of the HSG belt is detected first, the possibility and proceeding of slipping of the HSG belt are precluded by the self-removal logic that remove the possibility of slipping of the HSG belt and the external handling logic that records and stores the information on the possibility.

Therefore, it is possible to prevent the belt from being deteriorated and damaged by slipping when it is attempted to start the engine with the HSG.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An engine start stabilization method in a hybrid power system, comprising an HSG (Hybrid Starter & Generator) protection logic that includes:
attempting HSG-engine start that attempts to start an engine with an HSG belt;
recognizing slipping of the HSG belt that determines whether possibility of slipping of the HSG belt is high, after whether a condition for the number of revolution of the engine (RPM) is suitable and whether a condition for the number of revolution of the HSG (RPM) and the number of revolution of a crankshaft (CRK RPM) is suitable are checked, in the HSG-engine start;
checking slipping of the HSG belt that attempts again the HSG-engine start, with the HSG-belt not slipping, when the possibility of slipping of the HSG belt is determined to be high, and maintains a traveling state by using a driving motor when the HSG-engine start fails; and
storing an HSG-belt slipping condition that stores the condition applied to determine whether the possibility of slipping of the HSG belt is high, and applies some of stored condition values as prior values, when the HSG-engine start is attempted after the engine is stopped.

2. The engine start stabilization method in the hybrid power system as defined in claim 1, wherein the attempting of HSG-engine start is applied when the engine is started by the HSG when a vehicle is driven by the driving motor or stopped.

3. The engine start stabilization method in the hybrid power system as defined in claim 1, wherein the recognizing of slipping of the HSG belt is performed by:
a continuous condition mode that determines whether the possibility of slipping the HSG belt is high, on the basis of whether the number of revolution of the engine (RPM) satisfies the condition of a minimum number of revolution of the engine (Es)<a predetermined number of revolution of the engine, whether the condition of the difference of the numbers of revolution (Esd)={[the number of revolution of the HSG (HSG RPM)×pulley ratio]−[the number of revolution of the crankshaft (CRK RPM)]}>another predetermined number of revolution of the engine is satisfied when the condition is satisfied, and whether the satisfaction of the conditions satisfies a predetermined continuation time (Te); and
an accumulation condition mode that determines whether the possibility of slipping the HSG belt is high, on the basis of whether the condition of the difference of the accumulated number of revolution (Esds) generated between the number of revolution of the HSG (RPM) and the number of revolution of the crankshaft (CRK RPM)>another predetermined number of revolution of the engine is satisfied and whether the accumulated numbers of time of the satisfaction of the conditions (Ss)=a predetermine number of times.

4. The engine start stabilization method in the hybrid power system as defined in claim 3, wherein the predetermined number of revolution of the engine in the condition of the minimum number of revolution of the engine (Es)<the predetermined number of revolution of the engine in the continuous condition mode is 500 RPM, the another predetermined number of revolution of the engine in the condition of the difference of the numbers of revolution (Esd)={[the number of revolution of the HSG (HSG RPM)×pulley ratio]−[the number of revolution of the crankshaft (CRK RPM)]}>another predetermined number of revolution of the engine is 300 RPM and 900 RPM, and the continuation time (Te) is eight seconds.

5. The engine start stabilization method in the hybrid power system as defined in claim 4, wherein when it is satisfied that the another predetermined number of revolution of the engine is 300 RPM, whether the another predetermined number of revolution of the engine is 900 RPM is determined.

6. The engine start stabilization method in the hybrid power system as defined in claim 4, wherein the another predetermined number of revolution of the engine in the condition of the difference of the accumulated number of revolution (Esds)>another predetermined number of revolution of the engine in the accumulation condition mode is 1000 RPM and the predetermined number of times in the accumulate numbers of times (Ss)=a predetermined number of times is one hundred times at 200,000 RPM.

7. The engine start stabilization method in the hybrid power system as defined in claim 3, wherein the continuous condition mode and the accumulation condition mode are Or-condition.

8. The engine start stabilization method in the hybrid power system as defined in claim 7, wherein when the conditions of the continuous condition mode and the accumulation condition mode are not satisfied, it is determined that the possibility of slipping of the HSG belt when the engine is started by the HSG is very low, and a normal traveling mode is implemented.

9. The engine start stabilization method in the hybrid power system as defined in claim 7, wherein the predetermined number of revolution of the engine in the condition of the minimum number of revolution of the engine (Es)<the predetermined number of revolution of the engine in the continuous condition mode is 500 RPM, the another predetermined number of revolution of the engine in the condition of the difference of the numbers of revolution (Esd)={[the number of revolution of the HSG (HSG RPM)×pulley ratio]−[the number of revolution of the crankshaft (CRK RPM)]}>the another predetermined number of revolution of the engine is 300 RPM and 900 RPM, and the continuation time (Te) is eight seconds.

10. The engine start stabilization method in the hybrid power system as defined in claim 9, wherein when it is satisfied that the another predetermined number of revolution of the engine is 300 RPM, whether the another predetermined number of revolution of the engine is 900 RPM is determined.

11. The engine start stabilization method in the hybrid power system as defined in claim 7, wherein the another predetermined number of revolution of the engine in the condition of the difference of the accumulated number of revolution (Esds)>another predetermined number of revolution of the engine in the accumulation condition mode is 1000 RPM and the predetermined number of times in the accumulate numbers of times (Ss)=a predetermined number of times is one hundred times at 200,000 RPM.

12. The engine start stabilization method in the hybrid power system as defined in claim 1, wherein the checking of slipping of the HSG belt is performed by:
an immediate action mode logic that when the HSG-engine start fails and the possibility of slipping of the HSG belt is high, keeps an EV (motor) traveling mode when the vehicles is traveling, or implements an HEV (engine+motor) traveling mode after operating a motor after the motor is driven when the vehicle is not stopped, and implements the EV (motor) traveling mode when failure of the HSG-engine start is further checked, and prevents engine stop until the HSG belt protection logic is initialized, and then prevents an attempt of the HSG-engine start; and
an external handling logic that records and stores information applied to determine whether the possibility of slipping of the HSG belt is high.

13. The engine start stabilization method in the hybrid power system as defined in claim 12, wherein continuation of the EV (motor) traveling mode is checked, the implementation of the HEV (engine+motor) traveling mode is checked after the motor is operated, and then the implementation of the EV (motor) traveling mode after the motor is operated is checked.

14. The engine start stabilization method in the hybrid power system as defined in claim 12, wherein when the immediate action mode logic is not performed, whether MP-DTC stored prior to P-DTC is detected with the P-DTC, which is pending DTC, is determined as the reference of determination, when the MP-DTC is detected and until the HSG belt protection logic is initialized, engine stop is prevented and then the attempt of the HSG-engine start is prevented, the HEV (engine+motor) traveling mode is implemented after the motor is operated in an IG ST attempt when the MP-DTC is not detected, and the when it is checked that the P-DTC is removed by continuous checking, a delay action mode logic that initializes the HSG belt breakdown determination is implemented.

15. The engine start stabilization method in the hybrid power system as defined in claim 12, wherein the external handling logic stores P-DTC that is a pending DTC and turns on a warning light, determines the number of times of breakdown of the HSG belt and turns on another warning light and continuously checks whether a condition of turning off the light is satisfied, determines whether a condition of storing the P-DTC as C-DTC that is a confirm DTC is satisfied, turns on another warning light when the condition of storing C-DTC is satisfied, stores the C-DTC when the number of times whether a warm-up cycle normally continues is satisfied, and uses the C-DTC as information when the HSG belt protection logic is repeated.

16. The engine start stabilization method in the hybrid power system as defined in claim 15, wherein a service warning light is turned on and is turned off when a condition of turning off the service warning light is satisfied, when the number of times of HSG breakdown determination is one time,
an MIL warning light is turned on and is turned off when a condition of turning off the MIL warning light is satisfied, when the number of times of HSG belt breakdown determination is one or more times (two times and three times), and
the condition satisfying the C-DTC storing is HSG belt breakdown determination=one or more times (two times and three times).

17. The engine start stabilization method in the hybrid power system as defined in claim 15, the number of times where the warm-up cycle continues is forty times.
